(19) United States
(12) Patent Application Publication
(10) Pub. No.: US 2021/0406332 A1
(43) Pub. Date: Dec. 30, 2021

(54) CREATION OF A TIMELINE VIEW OF WORK PRODUCT AND WORKING RELATIONSHIPS OF INDIVIDUALS WITHIN AN ORGANIZATION

(71) Applicant: Microsoft Technology Licensing, LLC, Redmond, WA (US)

(72) Inventors: Torbjørn HELVIK, Olso (NO); Vegar S WANG, Tromsø (NO)

(73) Assignee: Microsoft Technology Licensing, LLC, Redmond, WA (US)

(21) Appl. No.: 16/917,340

(22) Filed: Jun. 30, 2020

(51) Int. Cl. G06F 16/9538; G06F 16/9536; G06F 16/908

(52) U.S. Cl. CPC G06F 16/9538; G06F 16/908; G06F 16/9536

(57) ABSTRACT

Examples of the present disclosure describe systems and methods for analyzing data items and relationships between those data items to create a time-based visualization of what particular individuals are working on and/or with whom particular individuals are working. The visualization may provide a brief summary of projects associated with the individual for a particular period of time.

### BACKGROUND

In many organizations and groups, especially large organizations and groups, it is common for members to work on various projects with a number of different individuals. However, it is often difficult to determine what projects and documents various individuals are working on, what skills and knowledge those individuals have accumulated, and with whom those individuals are working. It is also difficult to track and subsequently surface that information in a meaningful way.

### SUMMARY

Examples of the present disclosure describe systems and methods for analyzing data items and relationships between those data items to create a timeline view of what particular individuals are working on and/or with whom the particular individuals are working. As used herein, a data item can be a content item (e.g., a document, an electronic message, an audio file, a video file, a presentation and so on) or an entity (e.g., a particular individual, a group, an organization and so on).

As various individuals interact with content items (e.g., editing content items, authoring content items, collaborating with entities on content items, reading content items, citing content items in other documents) and/or other individuals, relationships between the content items and/or the individuals may be stored and subsequently detected. When input is subsequently received that specifies a particular term (e.g., a particular individual, a particular topic), these relationships may be used to surface results that provide information regarding past (or current) content items and/or projects related to the term. The information may include content items that are associated with the term, collaborators on content items associated with the term and so on. In some examples, the results of the query may be organized and provided in a visualization such as, for example, a timeline. Thus, the individual that provided the term can view a time-based summary of content items associated with the term.

Accordingly, aspects of the present disclosure describe a system comprising a processor and a memory communicatively coupled to the processor. The memory stores instructions that, when executed by the processor, perform operations. These operations may include detecting an input in a user interface provided on a display of a computing device and processing the input to identify a term. A search is performed on a data source using the term to identify search results. The search results include a set of content items associated with an entity. The search results are evaluated to determine a relationship between the set of content items and a set of data items. The set of content items and the set of data items are evaluated to identify a property associated with each content item in the set of content items and each data item in set of data items. A time-based visualization is generated and provided for display on the user interface of the computing device. The time-based visualization includes at least one content item from the set of content items and at least one data item from the set of data items. In some examples, the at least one content item and the at least one data item are ordered based, at least in part, on the property.

The present application also describes a method that includes receiving a visualization request. A search is performed on a data source using the visualization request to identify search results. The search results include a set of content items associated with an entity. The search results are evaluated to determine a relationship between the set of content items and a set of data items. The set of content items and the set of data items are evaluated to identify a property associated with each content item in the set of content items and each data item in set of data items. A time-based visualization is generated and provided for display on the user interface of the computing device. The time-based visualization includes at least one content item from the set of content items and at least one data item from the set of data items. In some examples, the at least one content item and the at least one data item are ordered based, at least in part, on the property.

Also described is method that includes detecting an input provided in a user interface on a display of a computing device. A search on a data source using the detected input is executed to identify a set of content items. An order of the set of content items is determined and the content items are evaluated to determine a relationship between the set of content items and a set of data items. A time-based visualization is generated and provided for display on the user interface. The time-based visualization includes the set of content items, including the order of the set of content items and the set of data items.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for analyzing data items and relationships between those data items to generate and display a time-based visualization according to an example.

FIG. 2 illustrates an example time-based visualization that may be provided to a computing device in response to a received search query according to an example.

FIG. 3 illustrates an example input processing system for analyzing data items and relationships between those data items according to an example.

FIG. 4 illustrates an example method for analyzing data items and relationships between those data items to generate a time-based visualization according to an example.

FIG. 5 is an example diagram of an entity and associated data items according to an example.

FIG. 6 is another example diagram of an entity and associated data items according to an example.

FIG. 7 is a system diagram illustrating example physical components of a computing device according to an example.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

In every organization and group, there are members that have different skills, experience, knowledge sets, and areas of expertise. Although such diversity of knowledge and experience may substantially enrich the efficacy, productivity, and culture of the organization or group as a whole, it may also introduce challenges.

As one example, members of different groups within an organization often possess different levels of knowledge on various topics and subject matter. For example, engineering team members may have a more technical understanding of a topic, product, or project than marketing team members. As such, it may be difficult to identify which members of different groups have an expertise in or experience with each of the various topics and what those members have been working on. Additionally, it may be difficult to identify with whom those individuals collaborated (thus identifying additional individuals that have an expertise and/or experience with each of the various topics), and/or which documents or other content items are relevant to a particular topic.

To address the challenges described above, the present application describes the generation of a visualization that shows or otherwise indicates content items that various individuals have created, commented on, collaborated on, cited, and/or reviewed. In some examples, the visualization is a timeline or is otherwise organized by time periods such that an individual that provides input for the query can visually see a summary or a snapshot of what projects, topics, subject matter, etc. various individuals have worked on in the past, what those individuals are currently working on, with whom those individuals are working, and with whom those individuals have worked with in the past. In some examples, the individual may request creation of the visualization described herein to view her own timeline view of current or past projects. The visualization described herein may increase collaboration between entities of a group or an organization as it helps individuals contextualize other individuals within the group or organization. The visualization may also help individuals understand the skills, experience and knowledge of the various individuals in their group or organization.

As such, the present application provides insights into a knowledgebase of various individuals in a group or organization. These insights are applicable to interactions between individuals that know each other and/or are familiar with each other's work. For example, content items that have been associated with interaction participants during a previous interaction may be used to establish a shared topic knowledge level for each of the participants.

Alternatively or additionally, these insights are applicable to interactions in which individuals may not have previously met or worked together. In such a case, each individual may be able to identify another individual with a particular expertise even if the individuals have never met or are otherwise unacquainted. As an example, content items that are associated with a particular individual may be used to contextualize the individual in preparation for an initial meeting or interaction.

The visualization and the data items provided in or otherwise associated with the visualization may show a summary or a snapshot of various projects (including, for example, documents, individuals, subject matter, topics, domains, etc.) that a particular individual is associated with or is working on (or worked on). The visualization may provide this summary for a determined or specified period of time. For example, when a search query or visualization request that specifies a particular individual is received, content items either directly or indirectly associated with that particular individual are identified and/or retrieved. Each content item may be associated with a specified or determined time period.

For content items associated with the specified time period, data items associated with the content items are identified. These data items may include other projects, persons, content items, subject matter, etc. In some examples, the results are aggregated to determine which data items are the most prominent when compared to the other data items. The most prominent data items may then be provided on the visualization.

For example, a particular individual, Cate Smith, may have authored forty documents in 2018. Twenty-eight of those documents may be associated with Project A, seven of those documents may be associated with Project B, three of those documents may be associated with Project C and two of those documents may be associated with Project D. Based on this information, the system may determine or infer that Project A and Project B were more important or more prominent projects for Cate Smith in 2018 when compared with the other identified projects. In some examples, a data item may be considered “popular” based on the above-determined information. Once the information about Project A and Project B is identified, information about Project A and Project B may be included in the visualization and associated with the year 2018. The visualization may also include information regarding other identified data items that have a determined relationship with Cate Smith.

A particular data item may be considered popular and/or prominent based on various factors, including those listed above. These factors may include an amount of time an individual or individuals spent reviewing, creating and/or editing a content item, a determined or known authority (e.g., whether the author or other contributor to the content item is known as or considered an expert in a particular field) associated with the content item, a number of times the content item has been cited by or referenced in another content item, and/or how often the content item is accessed. Although specific examples are given, other factors may be considered.

The relationships between various data items may be based, at least in part, on a detected or determined interaction between/with data items. Example interactions may include, but are not limited to, electronic/voice/video message exchanges between individuals, meetings attended by individuals, composing or editing a content item (e.g., documents, electronic messages, images, audio/video recordings), receiving or sending a content item, navigating to or within a content item or data source, consuming (e.g., viewing or listening to) a content item, requesting a search operation, collaborating on a content item with another individual, commenting on a content item, and so on. The relationship information may be used to search one or more data sources for relationships between various data items. Examples of data sources include databases (e.g., relational databases, graph databases), flat files and the like.

The relationships may correspond to explicit linking data and/or implicit linking data. Explicit linking data may include relationships explicitly defined by an individual and/or relationships explicitly referencing a data item. For example, an individual may create and/or affirmatively be identified as a co-author or collaborator of a document with another individual. The identification of the individual as a co-author or collaborator of the document in the data source (by an individual or a process of the data source) may be viewed as an explicit link between the individual and the document and/or the individual and the co-author. In yet another example, a link to a document or other content item associated with a first individual that is inserted into or otherwise associated with a second document associated with a second individual may define an explicit link between the first document and second document, the second document and the first individual and/or the first individual and the second individual.

Implicit linking data may include relationships implicitly defined by the data source or an associated application or service. For example, an artificial intelligence entity or system may analyze content, identify the subject matter of the content and determine, based on additional data (e.g., authorship data, co-authorship data), that a particular individual is associated with that subject matter. In another example, a first individual may have a role as a supervisor for a second individual. As such, any content produced by the second individual may be implicitly linked to the first individual. In some examples, a portion of content may be copied from a first document to a second document without an explicit reference back to the first document. As a result, the first document may be implicitly linked to the second document.

The system described herein may execute a query on one or more data sources in response to received input to identify search results. The received input may be any input received by a computing device. For example, the input may be a selection of, or a request for, a contact/profile card associated with an individual. The input may be a request to view an organization chart of a business or company. The input may be a search term provided in a user interface of a computing device. The input may be voice and/or video input. The search results may include data items such as content item and/or entities that are associated with the input.

In the following example, search results include a set of content items. However, entities may also be included the search results. The set content items may be associated with particular topics, subject matter and/or entities. Identifying the set of content items may include comparing one or more terms in the query to one or more terms or tags associated with various content items in the data sources. In examples, content item tags may indicate topics and concepts included in or relating to a content item.

After identifying the set content items, various relationships associated with the set of content items are evaluated to determine a set of data items that are related to or otherwise associated with the set of content items. The set of content items and/or the set of data items may be evaluated according to one or more properties, criterion or factors to determine a relevance score. Example criterion/factors include, but are not limited to, semantic similarity between terms in the search query, the set of content items and/or the set of data items; identified information and terms associated with the content items/data items in the data source; distance or number of data items (e.g., nodes) between a first data item and a second data item in the data source; relationship properties of the data items; other data item properties, and so on. In some examples, the relevance score may be based, at least in part, on a relationship between various content items and data items. Once the data items are identified, a visualization associated with the search term may be generated and provided on a display of a computing device.

Accordingly, the present disclosure provides a plurality of technical benefits including but not limited to: improving the identification of shared knowledge, identifying data items that are explicitly linked together, tracking and identifying implicitly linked data items, ranking content item importance, identifying biographical information and talking points for new and/or existing user contacts, and enabling entity contextualization which may help individuals understand or identify what skills, experience and knowledge various individuals already have, among other examples.

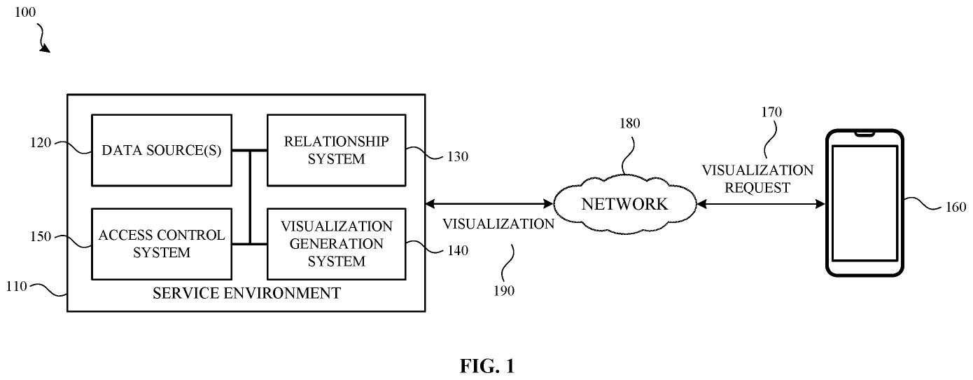

FIG. 1 illustrates an overview of an example system 100 for analyzing data items and relationships between those data items to generate and display a time-based visualization according to an example. The various systems shown in FIG. 1 are presented as a combination of interdependent components that interact to form an integrated whole. Components of the system may be hardware components or software components implemented on and/or executed by hardware components of the system. In one example, the system 100 may provide an operating environment for software components to execute and utilize resources or facilities of the system 100. In another example, the various systems disclosed herein may be distributed across multiple computing devices. For example, input may be entered on a client device and information may be processed or accessed from other devices in a network, such as one or more cloud or remote server devices.

In some examples, the system 100 may include a service environment 110. The service environment 110 may include one or more data sources 120, a relationship system 130, a visualization generation system 140 and an access control system 150. The system 100 may also include a network 180 that enables data to be transmitted between a computing device 160 and the service environment 110.

The scale of the system 100 may vary and may include more or fewer systems than those described with respect to FIG. 1. Examples of a computing device 160 include, but are not limited to, a personal computer (PC), a mobile device (e.g., smartphone/phone, tablet, laptop, personal digital assistant (PDA)), a wearable device (e.g., smart jewelry, a body-mounted device), or the like. In aspects, computing device 160 may comprise, or have access to, one or more software applications or services that detect and/or collect input from users using one or more sensor devices. Examples of software applications or services include, but are not limited to, presentation tools, word processing tools, spreadsheet tools, calendar/tasking tools, messaging and/or communication tools, content discovery/retrieval tools, personal digital assistant tools, etc. The collected input may include, for example, voice input, touch input, text-based input, gesture input, and/or video/image input. Examples of sensor devices include microphones, touch-based sensors, keyboards, pointing/selection tools, optical/magnetic scanners, accelerometers, magnetometers, gyroscopes, etc.

The computing device 160 may receive input in a user interface. The input may be in the form of a visualization request 170 for a particular data item or data items. For example, an individual may want to see a visualization for a particular entity “Cate Smith.” As such, the individual provides Cate Smith as input in the user interface, such as via voice or text. The visualization request 170 is parsed to determine the terms of the visualization request 170. The terms are subsequently provided to the service environment 110.

The computing device 160 may also receive input in the form of a data item from an individual. For example, Cate Smith may author a particular document and that document may be subsequently transmitted to the service environment 110 and stored in a data source 120. Upon receiving the data item, the service environment 110 may perform processing techniques to identify information (e.g., one or more terms, topics, entities, time/date information) relating to the data item. When the data item is received, the relationship system 130 may determine one or more relationships between the data item and one or more data items that are stored by the data source 120. In other examples, any relationships between various data items may not be determined until a query for a particular data item is executed by the system 100. In some examples, determined relationships between various data items may be determined on the fly (e.g., in response to received input) or determined when newly received data items are stored. In some examples, relationship data between the various data items may be stored and subsequently accessed in response to received visualization requests 170.

The determined relationships may be updated in real-time or substantially real-time. For example, if metadata associated with a particular content item identifies a first individual, Cate Smith, as an author of the content item and the metadata associated with the particular content item identifies a second individual, Luke Jones, as an individual that subsequently edited, commented on, or cited the content item in another content item, the relationship system 130 may update and/or create a relationship between Luke Jones, Cate Smith and/or the various content items and/or topics associated with the content items.

Referring back to the previous example, the input provided to the computing device 160 may be used to generate a visualization request 170. The visualization request 170 may be used to search data sources 120 for data items (e.g., content items, topics, entities, domains), relationship data, and/or property information associated with stored data items. Examples of data sources 120 include, but are not limited to, databases, data tables, data files, and similar data structures storing data.

If the input indicates that the individual wants to search for data items relating to Cate Smith, the individual may input the name Cate Smith into a search box of a user interface provided on the computing device 160. In another example, the input may be a selection of a link or other visual indicator (e.g., an icon or an image) associated with a data item. For example, a contact/profile card of an individual may include a visual indicator or link that indicates a visualization for this particular individual will be generated when the visual indicator or link is selected. In yet another example, the input may be voice/video input provided to the computing device 160.

When the input is provided, the visualization request 170 for Cate Smith may be provided to the service environment 110. Once the visualization request 170 is received, the service environment 110 may execute a query using the terms Cate Smith to determine a first set of one or more data items that are associated with Cate Smith. In this example, the first set of one or more data items may be one or more content items.

Once the first set data items are identified, the relationship system 130 may determine or otherwise identify various properties associated with the data items. The properties may identify a time period associated with each of the data items, a determined popularity and/or relevance score of data items associated with the input when compared to other data items associated with the input, a determined subject matter of the data item, and so on.

The relationship system 130 may determine relationships of each data item in the set of data items. In some examples, the relationship system 130 will only determine or identify relationships between data items that were identified as popular or relevant. Thus, if a score associated with a particular data item does not exceed a threshold, relationships associated with these data items will not be explored.

To qualify as a popular data item, one or more properties associated with the data item may be required to meet a particular popularity threshold. For example, for a domain, project, topic, or subject matter to be considered popular, a certain number of content items associated with the domain, the project, the topic, or the subject matter may need to be produced, edited, commented on, cited, etc. over a determined time period. In other examples, a data item is considered popular if one or more individuals have spent over a threshold amount of time viewing, reading, editing or creating the data item.

A particular entity may be considered popular if the particular entity has produced, commented on, or collaborated on a certain number of content items over a determined period of time. In yet another example, a data item may be considered popular if subject matter associated with the data item is trending (e.g., been viewed, discussed, edited over a threshold amount of times for a given time period), or has trended, over a particular time frame. While specifics are given, these are for example purposes only.

For a data item to be considered relevant, an artificial intelligence system or entity may analyze content associated with a data item, determine a subject matter of the content, compare the subject matter to a determined meaning of the search term and/or determine whether the content/subject matter of the data item is related to or otherwise associated with the determined meaning of the provided input. A data item may also be considered relevant to the received input if the data item is associated with a particular project or projects that are identified as being important or prominent such as previously described.

Continuing with the Cate Smith example, when Cate Smith is provided as input to the service environment 110, the service environment 110 may identify a content item entitled “Artificial Intelligence Project”. Specifically, metadata associated with the content item may indicate that this particular content item was co-authored by Cate Smith in 2019. Thus, this content item may be tagged or otherwise identified as a potential content item that will be provided on or otherwise associated with a subsequently generated time-based visualization 190. The service environment 110 may analyze the content of the content item to determine the subject matter associated with the content item. The determined subject matter may also be a candidate for display on the time-based visualization 190.

Property information associated with the Artificial Intelligence Project may indicate that this content item and/or the subject matter associated with the content item qualifies as relevant to the received input and/or popular. As such, the relationship system 130 may determine or identify relationship information between this particular content item and another data item. For example, metadata associated with this content item may indicate that another individual, Josh Christensen, was also a co-author of this particular content item.

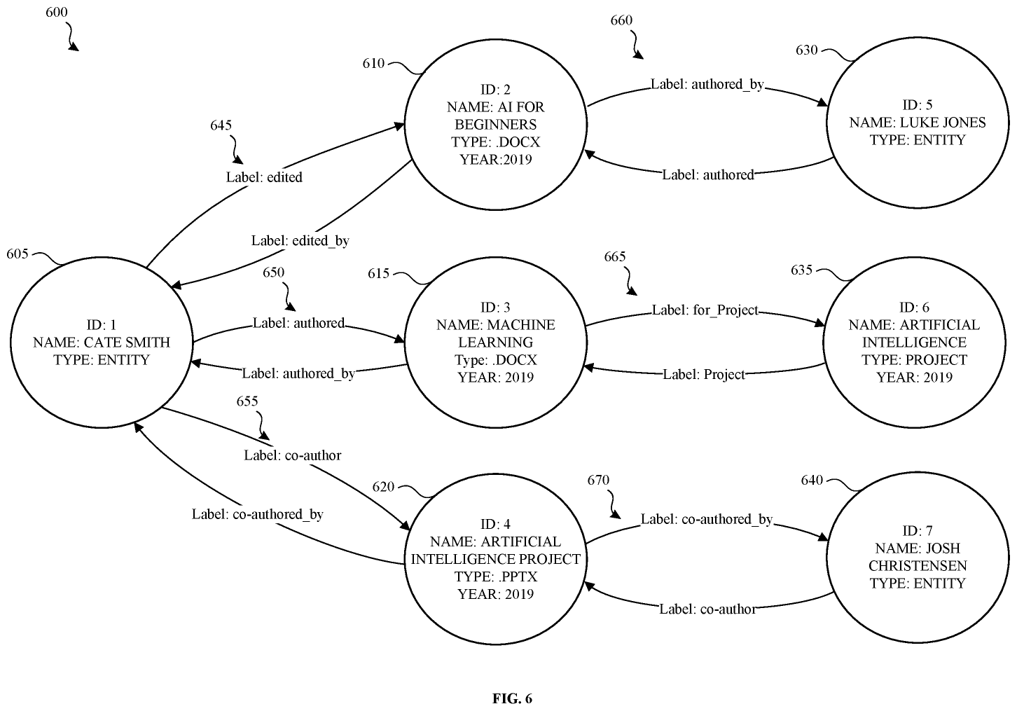

Further, relationship information associated with Cate Smith may show that Cate Smith authored a content item entitled “Machine Learning”. Metadata associated with this particular content item may indicate a relationship between this content item and another content item associated with a particular project entitled “Artificial Intelligence”. In the example shown in FIG. 6 and explained in greater detail below, the content items Artificial Intelligence Project and Machine Learning are linked with the Cate Smith and the content item Artificial Intelligence is linked to the content item Machine Learning. Thus, Cate Smith may be linked or otherwise have a relationship with the project entitled Artificial Intelligence.

The relationship system 130 may analyze various metadata associated with various content items in the data sources 120 to identify relationships for the various data items identified by or otherwise associated with the terms in the visualization request 170. For example, the relationship system 130 may analyze metadata of data items in the data sources 120 to identify data items that are associated with Cate Smith (e.g., content item in which Cate Smith is listed as an author or modifier during a particular time period). As explained above, the executed search may identify a first set of content items (e.g., content items in which Cate Smith is listed as an author) and subsequently identify a set of data items using known or discoverable relationships.

Although a specific example has been given, a visualization request 170 can be received for a general search phrase, an entity, a subject matter, etc. In some examples, one or more filters may be associated with the visualization request 170 to enable the individual to request a more granular search for data items.

Once various content items and/or data items for the visualization are identified, information associated with the content items and data items is analyzed to determine which data items and/or content items are more prominent when compared to other identified data items and content items. This information may include a name associated with the content item/data item, a relevance score of the content item/data item, the year and/or month the content item/data item was created, edited and/or accessed, collaborators associated with the content item/data item, a subject matter associated with the content item/data item, and/or projects associated with the content item/data item.

In some examples, the identified content items and/or data items may be grouped into various buckets based on a time period (e.g., a year, a month). In other examples, content items and/or data items may be grouped using other properties such as, for example, top collaborators or projects.

Each content item and/or data item for that particular time period may be aggregated together in order to determine which content items/data items are more prominent for that time period. Thus, for a particular year, and continuing with the Cate Smith example, a top collaborator of Cate Smith may be identified, the most prominent subject matter associated with Cate Smith may be identified, the top documents associated with Cate Smith and/or the top projects associated with Cate Smith may be determined (e.g., based on a popularity score) and provided in a visualization 190. In some examples, a higher relevance score of a particular content item or data item may cause that particular content item or data item to be displayed in the visualization 190 in lieu of another content item or data item—even if the particular content item has a lower popularity score.

As explained above, the identified content items and/or data items may be evaluated according to one or more properties, criterion and/or factors to determine a popularity and/or a relevance score. These factors may include the number of times a document has been accessed by various individuals (e.g., the author, collaborators, colleagues), a number of times the content item has been cited by other content items, a number of times the content item has been forwarded (e.g., via email or other electronic message), a number of times content from the content item has been copied into another content item, and/or an amount of time spent (e.g., reviewed, edited, accessed) on a particular content item.

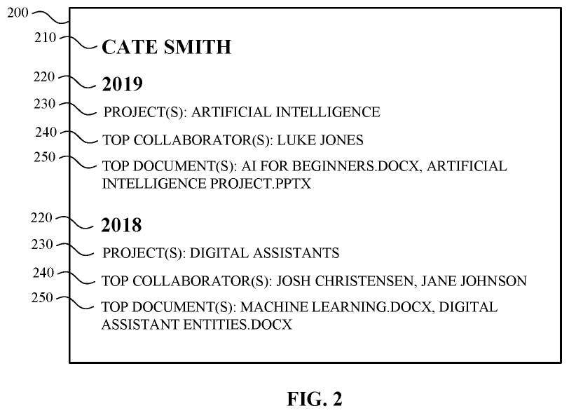

Once the most prominent content items and/or data items are identified, a visualization 190 (such as, for example, a timeline or other time-based visualization) is generated and provided to the computing device 160. In some examples, the visualization 190 is generated by the visualization generation system 140. An example visualization is shown in FIG. 2.

The visualization 200 shown in FIG. 2 includes various types of information that provides a requesting individual a summary or a snapshot of the various collaborators, projects, documents, subject matter that are directly and/or indirectly associated with a term (e.g., Cate Smith) in the visualization request. The visualization 200 may be organized or otherwise provide information for a given time period (e.g., 2018, 2019).

In the example shown in FIG. 2, the visualization 200 includes a name 210 of the entity on which the query was performed. The visualization 200 may also include a time period 220 with which identified content items are associated. The visualization 200 may also include a determined subject matter 230 associated with the identified content items, collaborators 240 on the various content items, and/or content items (e.g., documents) 250 associated with the subject matter 230. As previously discussed, information about the content items and data items that are selected for display on the visualization 200 may be based on various properties (e.g., a determined or identified popularity, a determined relevance score in light of the visualization request) associated with the data items and content items.

Each item in the visualization 200 may be selectable. Thus, when one of the items is selected, an additional search may be executed. In one example, the search may be a new search. For example, if the individual selects Luke Jones, a search may be executed for content items authored by, or otherwise associated with, Luke Jones. In another example, a received input of Luke Jones may be aggregated with the search that was previously conducted. As a result, the visualization 200 would only show content items in which a relationship between Cate Smith, Luke Jones, and other content items was identified. For example, if Luke Jones does not also have a relationship with collaborators Jane Johnson and Josh Christensen, these collaborators and/or any documents for which Jane Johnson and Josh Christensen are listed as authors, collaborators, etc. would be removed from the visualization 200.

In another example, selection of a particular content item provided in the visualization 200 may provide the individual access to the content item. For example, if an individual provides input to a computing device in which the Machine Learning document is selected, the individual is provided access to the document, provided that the individual has the relevant permissions and/or access privileges.

In some examples, access to the content items and other such information provided on the visualization 200 may be limited and/or removed from the visualization 200 based on various permission/access levels associated with the content item. For example, if metadata associated with a particular content item indicates that access rights for the content item are limited, the content item will not be provided on any visualizations that are generated for individuals that do not have the required access rights. In another example, a content creator (e.g., author, co-author, collaborator) may restrict access to and/or remove content from being discoverable and/or otherwise provided on the visualization 200.

Referring back to FIG. 1, the above-mentioned access control features may be provided by the access control system 150. In some examples, any personal information that is collected or stored by the various systems described herein is securely stored. Additionally, an individual may opt in to or opt out of the collection/storage of personal information, may view and/or correct the personal information that is stored, etc.

Although the above examples are directed to a visualization request 170 in which a name of an individual is provided, the visualization request 170 may specify any entity, content item, subject matter, domain and so on. Additionally, multiple queries may be executed to further narrow results. For example, instead of executing a search for Cate Smith, the query that is received may be a natural language query for “return all documents that Cate Smith contributed to and that relate to artificial intelligence”.

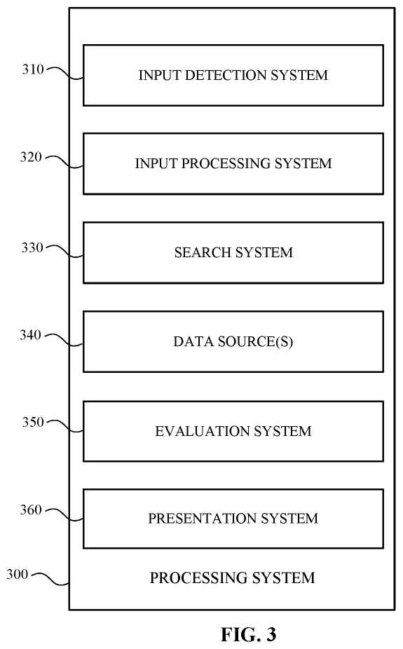

FIG. 3 illustrates an example input processing system 300 for analyzing data items and relationships between those data items according to an example. The processing system 300 may be used to identify a first or initial set of data items associated with received input, such as, for example, a visualization request. For example, if the first set of data items have a property called “keywords”, this property may be used to identify one or more data items that could or would be included on a visualization (provided the keyword is associated with the received input). In another example, the processing system 300 may determine relationships between the first set of data items and a second set of data items. In this example, the processing system may surface that information in the form of a visualization such as described herein.

The processing system 300 may be part of a service environment (e.g., service environment 100 (FIG. 1)) and may include an input detection system 310, an input processing system 320, a search system 330, a data source(s) 340, an evaluation system 350, and a presentation system 360. One of skill in the art will appreciate that the scale of the processing system 300 may vary and may include additional or fewer systems than those described with respect to FIG. 3. For example, the functionality of the input processing system 320, the search system 330, and/or the evaluation system 350 may be combined into a single component, model, or algorithm.

The input detection system 310 may be configured to receive or detect input from one or more individuals or computing devices, such as computing device 160 (FIG. 1). The input may include audio data, touch data, text-based data, gesture data, video/image data, etc. Detecting the input may include using one or more background processes to monitor and/or capture received input in real-time or substantially real-time.

Upon receiving input, the input detection system 310 may perform one or more pre-processing steps. The pre-processing steps may include, for example, parsing the input into one or more input types (e.g., audio data, video data, text data), identifying user/device identifiers (e.g., user/account name, device name/type), identifying entry point information (e.g., an application or service used to collect the input), identifying date/time information, identifying input attributes (e.g., length of input, subject and/or content of input), storing and/or labeling the input, etc. The input detection system 310 may provide the input and/or pre-processed data to the input processing system 320.

The input processing system 320 may be configured to perform one or more post-processing steps. The post-processing steps may include, for example, identifying one or more terms, entities, or topics in or relating to the input, identifying terms that are synonymous or similar to terms in the input, identifying one or more topics or categories associated with input, modifying the input to include additional or fewer terms, generating search queries and/or subqueries based on the input, identifying data sources comprising data associated with the input, etc. The input processing system 320 may provide the input and/or the post-processed data to the search system 330.

The search system 330 may be configured to search for data items using the input and/or the post-processed data and identify a first set of data items. In some examples, the search system 330 may use the input and/or the post-processed data identify one or more search results (e.g., topics, content items, entities, relationships, associated properties) in one or more data sources, such as data source(s) 340. Data source(s) 340 may be configured to store and provide access to various content, such as user data (e.g., user account files, user profiles, personal information manager (PIM) files), device data, application data (e.g., user contact files, email files, calendar files, chat session files, presentation files, word processing files, spreadsheet files), and other electronic documents (e.g., books, magazines, white papers, news articles, blogs). Identifying the search results may include traversing the content and structure of a data source and/or using a pattern matching technique. For example, the various nodes and edges of a data source, such as a graph database, may be traversed to identify content item tags and properties connecting or otherwise related to terms in the input.

Once the set of data items is identified, the evaluation system 350 may determine or otherwise identify various properties associated with each data item in the set. Although a set of data items is mentioned, it is contemplated that a single data item may be identified. In some examples, the properties may include a determined popularity of the data items. In other examples, a property may indicate a time period associated with the data item. In another example, the property may be a determined subject matter or topic of the data item. In another example, the property may be a relevance score of a data item. For example, an artificial intelligence system or entity may analyze the data item, determine a subject matter/content of the data item, compare the subject matter to a determined meaning of the search term and determine whether the content/subject matter of the data item is related to or otherwise associated with the determined meaning of the search term.

The search system 330 may also evaluate relationships or relationship pairs associated with the first set of data items to identify a second set of data items. In some examples, the relationship determination may be made for each data item in the first set of data items associated with the received input. In other examples, the relationship determination may be made for data items that are identified as popular or relevant when compared with other data items associated with the received input.

Identifying the first set of data items and/or the second set of data items may include traversing the content and structure of a data source and/or using a pattern matching techniques. For example, the various nodes and edges of a data source, such as a graph database, may be traversed to identify content item tags and properties connecting or otherwise related to terms in the input. The search system 330 may provide all of the search results to the evaluation system 350 such as previously described. In some examples, identification of the first set of data items and/or the second set of data items may be accomplished by applying a filter to data items stored in the data sources and/or applying a filter to the first set of items to identify the second set of items.

The evaluation system 350 may be configured to evaluate identified content items and/or data items that were identified by the search system 330. Evaluating the results may include applying one or more criterion or assessing one or more factors. Example criterion/factors include semantic similarity between terms in the input and terms associated with the search results, distance between a first data item and a second data item in a visualization of a data source, number of data items or nodes between a first data item and a second data item in a visualization of a data source, relationship properties of the data items in a data source, properties for data items, and so on.

In some examples, the evaluation system 350 generates scores or ratings for one or more of the search results. Generating scores or ratings may include assigning criterion/factor scores and/or weighting factors to one or more of the various criterion/factors used to evaluate the search results. The various criterion/factor scores for each search result may be combined to form a search result score. In at least one example, the search result scores may be sorted, ranked, and/or classified. The rankings or classification may indicate a popularity of the data item, a relevance score of the data item, a knowledge level of an individual or individuals that collaborated, created, commented on, and/or authored the one or more content items, etc. The evaluation system 350 may provide the evaluated search results to the presentation system 360.

The presentation system 360 may generate and/or provide a time-based visualization associated with the search results. In some examples, the visualization may be similar to the visualization 200 shown and described with respect to FIG. 2.

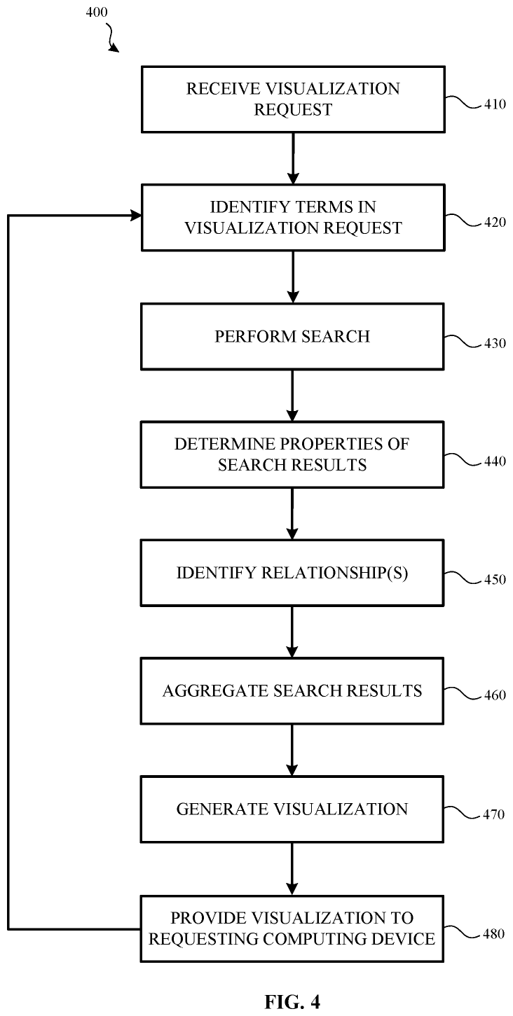

FIG. 4 illustrates an example method for analyzing data items and relationships between those data items to generate a time-based visualization according to an example. Method 400 may be performed by the various systems described herein such as, for example, the system 100 shown and described with respect to FIG. 1.

The method 400 begins when a visualization request is received (410). In some examples, the visualization request is a natural language input provided to a computing device. In other examples, the visualization request is another type of input such as, for example, selecting a link, selecting an icon, selecting an image, or otherwise requesting information associated with an entity, subject matter or topic. The visualization request may include a single term or multiple terms. The visualization request may specify an entity, a subject matter, a time period, a topic, a domain or domain-specific associations (e.g., mathematical subject classification, artificial intelligence subject classifications) and so on. In some examples, the visualization request is provided in a user interface of an application or other program executing on a computing device.

Once the visualization request is received, the terms in the visualization request are identified (420). In some examples, identification of terms in the visualization request includes parsing the visualization request to determine various content items of interest for the visualization request and subsequently generating a query that can be executed on various data sources. In other examples, the visualization request is parsed to identify relationships that should be considered when the system executes the query.

For example, a visualization request for Cate Smith may cause the system to generate and execute a query in the following form: query=(author:CateSmith OR modifier:CateSmith) AND (lastModifiedTime>=2019-01-01 AND lastModifiedTime<=2019-12-31) which would return content items that Cate Smith is associated with during the year 2019. In order to continue adding additional information to the visualization, the system may automatically generate a second query in the following form: query=(author:CateSmith OR modifier:CateSmith) AND (lastModifiedTime>=2018-01-01 AND lastModifiedTime<=2018-12-31) to identify data items associated with Cate Smith in 2018. Although a second query is mentioned, the system may apply a filter to identified data items in order to generate a desired visualization. Additionally, although specific examples are given, additional queries and/or filters may be automatically generated/applied based on different types of received input.

Identifying terms may also include identifying one or more additional terms, entities, or topics in or relating to the received input. Identifying terms may also include identifying terms that are synonymous with or similar to terms in the received input. The identification of terms may also include identifying one or more topics or categories associated with the received input, modifying the received input (e.g., adding and/or removing terms), generating subqueries based on the received input, identifying data sources comprising data associated with the received input, etc.

Once the terms of the query have been identified, a search (430) is performed using the generated query. In some examples, the generated query may be used to search one or more data sources for various data items, topics, relationships, associated properties, etc. Searching the data source(s) may include using a search utility, such as a processing system 300 (FIG. 3), and regular expressions, fuzzy logic, a pattern recognition model/equation, or other search techniques. In some examples, the search may be limited or otherwise restricted by various access control systems such as previously described.

Upon identifying a first set of one or more search results (e.g., content items), the search results may be analyzed to determine (440) various properties of the search results. The properties may include a determined popularity of each of the search results, a topic associated with each of the search results, a subject matter associated with each of the search results, a time period associated with each of the search results, a relevance score associated with the search results, and so on.

Relationships between the search results and various other data items in the data sources may be identified (450). Identifying relationships may include traversing the content and structure of one or more data sources. In some examples, the relationships may be used to identify a second set of one or more search results (e.g., data items) that are linked to or are otherwise associated with the first set of one or more search results.

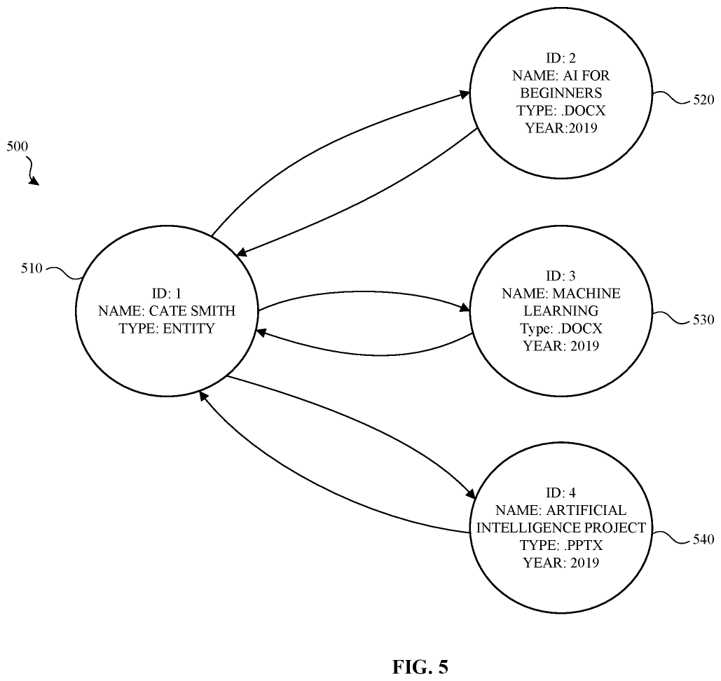

FIG. 5 (and FIG. 6, described in more detail below) illustrates an example structure, such as a knowledge graph, that may be used to identify content items that are associated with a particular entity. Although content items and entities are specifically discussed, a structure (and a search of the structure) may be used to identify various data items.

FIG. 5 illustrates an example diagram 500 of an entity 510 and associated data items. Diagram 500 comprises nodes 510, 520, 530, and 540. Node 510 represents the entity “Cate Smith” and is connected to nodes 520, 530, and 540. Node 520 represents the content item “AI for Beginners” document, node 530 represents the content item “Machine Learning” document, and node 540 represents the content item “Artificial Intelligence Project” presentation. Although specific types of content items are shown and described, the various content items may have any format (e.g., video, audio, electronic message, and so on).

A search utility may traverse out from node 510 to identify nodes 520, 530, and 540 and/or corresponding relationship information between the nodes. Various pattern matching techniques may be used to determine that the search term Cate Smith identified in the received input relates to the nodes 520, 530, and 540. Accordingly, the corresponding documents and presentation may be added to a set of search results.

Referring back to FIG. 4, once the relationships are identified, the first set of one or more search results may then be aggregated (460) with the second set of one or more search results in order to find the content items and/or data items that are more prominent when compared to other content items/data items.

As indicated above, the search results may be evaluated based on one or more properties, criterion or factors. Examples include semantic similarity between terms in the input and terms associated with the search results (e.g., exact matches may be prioritized over partial matches, acronyms may be prioritized over synonyms), distance between a first content item and a second content item in a visualization of a data source (e.g., close proximity nodes may be prioritized over nodes farther away), number of content items or nodes between a first content item and a second content item in a visualization of a data source (e.g., direct relationships between two nodes may be prioritized over node relationship comprising intervening nodes), relationship properties of the content items and/or entities in a data source (e.g., authoring a document is more indicative of knowledge than viewing a document, viewing a document is more indicative of knowledge than receiving a document), properties for content items (e.g., create/modify dates, authoritativeness, popularity, number of views, number of times referenced, viewer session metrics), properties for entities (e.g., area of expertise, experience, number of publications, awards, educational details, role/title, number of documents produced, number of documents co-authored, number and/or types of comments provided), publication dates, creation date, date of comments or other input, among others.

The system may generate (470) a time-based visualization. The time-based visualization may include only data items and/or content items that are determined to be more prominent such as previously described. The time-based visualization that is generated may be similar to the visualization 200 shown and described with respect to FIG. 2. Once the time-based visualization has been generated, the system provides (480) the time-based visualization to the requesting computing device.

In some examples, the granularity of the time-based visualization may be changed and/or adjusted based on received input. For example, if the time-based visualization shows Cate Smith worked on various documents during 2019, input may be provided to filter the various documents by a smaller time interval, such as month of the year. In another example, a larger time interval (e.g., multiple years) may be selected. Thus, popular projects and/or document associated with an individual over the individual's tenure at an organization may be generated and viewed. In other aspects, a particular content item in the time-based visualization may be selected. As such, the method 400 may be repeated (shown by the directional arrow from operation (480) to operation (420)) and the search terms aggregated to show additional results. In yet another example, selection of a particular content item (e.g., a document) may cause the content item to be opened or otherwise accessible.

FIG. 6 illustrates another example diagram 600 of an entity and associated data items according to an example. Diagram 600 comprises nodes 605, 610, 615, 620, 630, 635, and 640 and relationship pairs 645, 650, 655, 660, 665, and 670. Nodes 605, 630 and 640 represent the entities Cate Smith, Luke Jones, and Josh Christensen respectively. Nodes 610, 615, and 620, each represent a different content items and node 635 represents a project.

Relationship pairs 645, 650, 655, 660, 665, and 670 define the various relationships between the entities, the content items, and the project. Thus, each of the relationship pairs may be used to identify various data items for the time-based visualization. In some examples, an evaluation system may evaluate diagram 600 to generate one or more scores in addition to the generation of the time-based visualization associated with a visualization request.

As one example, with respect to node 605, a visualization request specifying Cate Smith may provide information that Cate Smith edited (represented by the relationship pair edited/edited_by 645) the document AI for Beginners (represented by node 610), authored (represented by the relationship pair authored/authored_by 650) the document Machine Learning (represented by node 615) and co-authored (represented by the relationship pair co-authored/co-authored_by 655) the Artificial Intelligence Project presentation (represented by node 620). As such, one, some, or all of these content items may be identified as potential candidates for display on a time-based visualization.

Once these content items are identified, a relevance score and/or a popularity score for each content item may be determined. The content items may be ranked based, at least in part, on the determined score(s). Relationships (represented by relationship pairs 660, 665, and 670) between the identified content items (represented by nodes 610, 615 and 620) and other data items may then be identified. In some examples, relationships between the content items and other data items will only be identified for content items that have popularity and/or relevance scores above a threshold.

In the example shown in FIG. 6, the document AI for Beginners (represented by node 610) has a relationship (authored/authored_by 660) with Luke Jones (represented by node 630). The Machine Learning document (represented by node 615) has a relationship (for_Project/Project 665) with the project entitled Artificial Intelligence (represented by node 635) and the presentation entitled Artificial Intelligence Project (represented by node 620) has a relationship (co-authored/co-authored_by 670) with the entity Josh Christensen (represented by node 640).

When these relationships are determined, various types of information about the identified content items and data items may be identified and/or stored (e.g., in a data table). This information may include a name associated with the content item/data item, a score associated with the content item/data item, a time period associated with the content item/data item, collaborators on a content item/data item, subject matter associated with the content item/data item, and projects associated with the content item/data item.

This information may then be used to aggregate various content items and/or data items together. In some examples, the aggregation enables the system to determine the most prominent content items and/or data items with respect to other identified content items/data items. Prior to aggregating, the identified content items/data items may be grouped using one or more of the identified properties (e.g., year, month, subject matter) and the aggregation may be performed for each group. Once the data items are aggregated, a determination of the most prominent collaborators, content items, subject matter, projects, etc. may be provided in a visualization such as described herein.

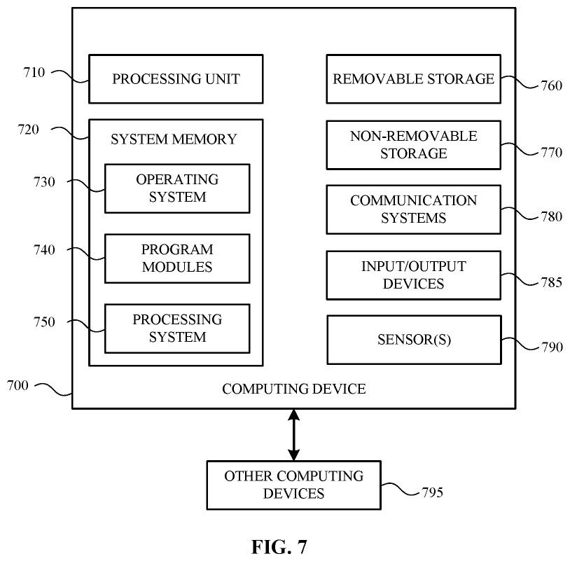

FIG. 7 is a system diagram of a computing device 700 according to an example. The computing device 700, or various components and systems of the computing device 700, may be integrated or associated with the various systems and/or subsystems described herein. As shown in FIG. 7, the physical components (e.g., hardware) of the computing device are illustrated and these physical components may be used to practice the various aspects of the present disclosure.

The computing device 700 may include at least one processing unit 710 and a system memory 720. The system memory 720 may include, but is not limited to, volatile storage (e.g., random access memory), non-volatile storage (e.g., read-only memory), flash memory, or any combination of such memories. The system memory 720 may also include an operating system 730 that controls the operation of the computing device 700 and one or more program modules 740. The program modules 740 may be responsible for receiving input, generating and/or determining relationships, generating visualizations and so on. Additionally or alternatively, the processing system 750 may be responsible for receiving input, generating and/or determining relationships, generating visualizations and so on. The memory 720 may also store and/or provide similar information and details. While executing on the processing unit 710, the program modules 740 may perform the various processes described above.

The computing device 700 may also have additional features or functionality. For example, the computing device 700 may include additional data storage devices (e.g., removable and/or non-removable storage devices) such as, for example, magnetic disks, optical disks, or tape. These additional storage devices are labeled as a removable storage 760 and a non-removable storage 770.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 7 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 700 on the single integrated circuit (chip). The disclosure may also be practiced using other technologies capable of performing logical operations such as, for example, AND, OR, and NOT, including but not limited to mechanical, optical, fluidic, and quantum technologies.

The computing device 700 may include one or more communication systems 780 that enable the computing device 700 to communicate with other computing devices 795. Examples of communication systems 780 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 700 may also have one or more input devices and/or one or more output devices shown as input/output devices 785. These input/output devices 785 may include a keyboard, a sound or voice input device, haptic devices, a touch, force and/or swipe input device, a display, speakers, etc. The aforementioned devices are examples and others may be used. The computing device 700 may also include various sensors 790 such as described herein.

The term computer-readable media as used herein may include computer storage media. Computer storage media may include volatile and nonvolatile, removable and non-removable media implemented in any method or technology for storage of information, such as computer readable instructions, data structures, or program modules.

The system memory 720, the removable storage 760, and the non-removable storage 770 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Accordingly, the present application describes a system, comprising: a processor; and a memory communicatively coupled to the processor and storing instructions that, when executed by the processor, perform operations, comprising: detecting an input in a user interface provided on a display of a computing device; processing the input to identify a term; searching a data source using the term to identify search results, the search results comprising a set of content items associated with an entity; evaluating the search results to determine a relationship between the set of content items and a set of data items; evaluating the set of content items and the set of data items to identify a property associated with each content item in the set of content items and each data item in set of data items; generating a time-based visualization comprising at least one content item from the set of content items and at least one data item from the set of data items, the at least one content item and the at least one data item being ordered based, at least in part, on the property; and providing for display on the user interface of the computing device, the time-based visualization. In some examples, the relationship corresponds to at least one of: composing a data item; editing a data item; collaborating on a data item; or providing comments about a data item. In some examples, the property is associated with a time period. In some examples, the property is associated with a relevance score. In some examples, the relevance score is based, at least in part, on a distance between nodes in the data source. In some examples, the relevance score is based, at least in part, on a determined subject matter associated with the data item. In some examples, the instructions further comprise instructions for determining an order for the set of content items. In some examples, the instructions further comprise instructions for altering a weight of the property based, at least in part, on the determined order for the set of content items. In some examples, the at least one data item is associated with an entity. In some examples, the at least one data item is a content item.

The present application also describes a method, comprising: receiving a visualization request; searching a data source using the visualization request to identify search results, the search results comprising a set of content items associated with an entity; evaluating the search results to determine a relationship between the set of content items and a set of data items; evaluating the set of content items and the set of data items to identify a property associated with each content item in the set of content items and each data item in set of data items; generating a time-based visualization comprising at least one content item from the set of content items and at least one data item from the set of data items, the at least one content item and the at least one data item being ordered based, at least in part, on the property; and providing for display on the user interface of the computing device, the time-based visualization. In some examples, the relationship corresponds to at least one of: composing a data item; editing a data item; collaborating on a data item; or providing comments about a data item. In some examples, the property is associated with a time period. In some examples, the property is associated with a relevance score. In some examples, the relevance score is based, at least in part, on a distance between nodes in the data source. In some examples, the relevance score is based, at least in part, on a determined subject matter associated with the data item. In some examples, the method further comprises determining an order for the set of content items. In some examples, the method comprises altering a weight of the property based, at least in part, on the determined order for the set of content items.

Also described is a method, comprising: detecting an input provided in a user interface on a display of a computing device; searching a data source using the detected input to identify a set of content items; determining an order of the set of content items; evaluating the search results to determine a relationship between the set of content items and a set of data items; generating a time-based visualization of the set of content items, including the order of the set of content items, and the set of data items; and providing for display on the user interface of the computing device, the time-based visualization. In some examples, at least one data item in the set of data items is associated with an entity.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system, comprising:
a processor; and
a memory communicatively coupled to the processor and storing instructions that, when executed by the processor, perform operations, comprising:
detecting an input in a user interface provided on a display of a computing device;
processing the input to identify a term;
searching a data source using the term to identify search results, the search results comprising a set of content items associated with an entity;
evaluating the search results to determine a relationship between the set of content items and a set of data items;
evaluating the set of content items and the set of data items to identify a property associated with each content item in the set of content items and each data item in set of data items;
generating a time-based visualization comprising at least one content item from the set of content items and at least one data item from the set of data items, the at least one content item and the at least one data item being ordered based, at least in part, on the property; and
providing for display on the user interface of the computing device, the time-based visualization.

2. The system of claim 1, wherein the relationship corresponds to at least one of:
composing a data item;
editing a data item;
collaborating on a data item; or
providing comments about a data item.

3. The system of claim 1, wherein the property is associated with a time period.

4. The system of claim 1, wherein the property is associated with a relevance score.

5. The system of claim 4, wherein the relevance score is based, at least in part, on a distance between nodes in the data source.

6. The system of claim 4, wherein the relevance score is based, at least in part, on a determined subject matter associated with the data item.

7. The system of claim 1, further comprising determining an order for the set of content items.

8. The system of claim 7, further comprising instructions for altering a weight of the property based, at least in part, on the determined order for the set of content items.

9. The system of claim 1, wherein the at least one data item is associated with an entity.

10. The system of claim 1, wherein the at least one data item is a content item.

11. A method, comprising:
receiving a visualization request;
searching a data source using the visualization request to identify search results, the search results comprising a set of content items associated with an entity;
evaluating the search results to determine a relationship between the set of content items and a set of data items;
evaluating the set of content items and the set of data items to identify a property associated with each content item in the set of content items and each data item in set of data items;
generating a time-based visualization comprising at least one content item from the set of content items and at least one data item from the set of data items, the at least one content item and the at least one data item being ordered based, at least in part, on the property; and
providing for display on the user interface of the computing device, the time-based visualization.

12. The method of claim 11, wherein the relationship corresponds to at least one of:
composing a data item;
editing a data item;
collaborating on a data item; or
providing comments about a data item.

13. The method of claim 11, wherein the property is associated with a time period.

14. The method of claim 11, wherein the property is associated with a relevance score.

15. The method of claim 14, wherein the relevance score is based, at least in part, on a distance between nodes in the data source.

16. The method of claim 14, wherein the relevance score is based, at least in part, on a determined subject matter associated with the data item.

17. The method of claim 11, further comprising determining an order for the set of content items.

18. The method of claim 17, further comprising altering a weight of the property based, at least in part, on the determined order for the set of content items.

19. A method, comprising:
detecting an input provided in a user interface on a display of a computing device;
searching a data source using the detected input to identify a set of content items;
determining an order of the set of content items;
evaluating the search results to determine a relationship between the set of content items and a set of data items;
generating a time-based visualization of the set of content items, including the order of the set of content items, and the set of data items; and
providing for display on the user interface of the computing device, the time-based visualization.

20. The method of claim 19, wherein at least one data item in the set of data items is associated with an entity.
